(19) United States
(12) Patent Application Publication
(10) Pub. No.: US 2012/0034479 A1
(43) Pub. Date: Feb. 9, 2012

(54) ENDLESS BELT FOR ELECTROPHOTOGRAPHIC DEVICE

(75) Inventors: Teruyoshi Kimpara, Kasugai-shi (JP); Shinichi Natsume, Iwakura-shi (JP); Shigeki Kanda, Kitanagoya-shi (JP); Tsukasa Fujita, Kasugai-shi (JP); Satoshi Endo, Kasugai-shi (JP)

(73) Assignee: TOKAI RUBBER INDUSTRIES, LTD., Komaki-shi (JP)

(21) Appl. No.: 13/204,285

(22) Filed: Aug. 5, 2011

(30) Foreign Application Priority Data
Aug. 6, 2010 (JP) 2010-177758

(51) Int. Cl. B32B 27/08; C08L 9/02; C08L 9/06; C08L 11/00; C08L 23/22

(52) U.S. Cl. 428/473.5; 524/552; 524/574; 524/575; 524/566

(57) ABSTRACT

An endless belt for an electrophotographic device having high degrees of flexibility and wear resistance in a surface portion of the elastic layer is provided. The endless belt for an electrophotographic device, includes a base layer, and an elastic layer which is formed on a surface of the base layer, by using a rubber composition including at least one rubber material and at least one inorganic filler in which the elastic layer has 40-75% by mass of a total organic component, and a product P of an indentation Young's modulus (MPa) α and a fracture strain (%) β that is within a range of 6000-50000.

The present application is based on Japanese Patent Application No. 2010-177758 filed Aug. 6, 2010, the contents of which are incorporated herein by reference.

### BACKGROUND OF THE INVENTION

1. Field of the Invention

The present invention relates to an endless belt for an electrophotographic device, and more particularly to an intermediate image transfer belt or other endless belt suitably usable for a full-color LBP (laser beam printer), a full-color PPC (plane paper copier) or other electrophotographic device which utilizes an electrophotographic technology.

2. Description of Related Art

In a conventional full-color LBP, a full-color PPC or other electrophotographic device utilizing an electrophotographic technology, an electrically conductive endless belt (seamless belt) is used for various purposes. For example, an intermediate image transfer belt is widely known as an endless belt for an electrophotographic device wherein a toner image formed on a photosensitive body (drum) is initially transferred to a surface of the intermediate image transfer belt, and the toner image transferred to the surface of the intermediate image transfer belt is then transferred to a recording medium such as a paper sheet.

There has been a need for increasing the printing speed of the electrophotographic device and prolonging its service life. Accordingly, the endless belt as a component of the electrophotographic device is required to permit a high-speed printing operation of the electrophotographic device and to have a prolonged service life. In view of this requirement, it is proposed to use a synthetic resin belt (resin belt) having a high degree of rigidity, as disclosed in JP-A-2001-152013.

The electrophotographic device using such a resin belt as the intermediate image transfer belt is configured to change a feeding speed of the recording medium depending upon the quality or characteristics of the recording medium, for ensuring a sufficiently high degree of image transfer efficiency and maintaining a high quality of the image transferred to the recording medium, even where the recording medium has a relatively rough recording surface, a relatively large thickness, or a relatively low quality. Although this configuration assures a sufficiently high quality of the image transferred to the recording medium, the electrophotographic device still suffers from a potential problem of a failure to perform a uniform velocity motion of the recording medium. For solving this problem, various electrically conductive belts or endless tubular films having an elastic layer formed of a rubber material on a surface of a base layer of a synthetic resin are proposed, as disclosed in JP-A-2007-240939. Most of those electrically conductive belts (endless belts for the electrophotographic device) having the elastic layer formed of the rubber material contain various kinds of additives such as an inorganic filler, for assuring a high degrees of formability and fire resistance, and for reducing a cost of manufacture, for instance.

However, the endless belts having the elastic layer containing the inorganic filler and other additives have a risk of failure of the elastic layer to exhibit desired physical properties (desired flexibility, in particular), if the contents of the additives (inorganic filler, in particular) in the elastic layer are excessively large. Described in detail, the endless belts the elastic layer of which has an excessively large content of the inorganic filler have a low degree of flexibility, giving rise to a risk of failure to assure a desired transfer of the toner image, and a risk of a superficial removal of the elastic layer due to friction between the surface of the elastic layer and the recording medium (paper sheet) or a belt cleaning member, when used for a long period of time as the intermediate image transfer belt in the electrophotographic device.

In view of the problems described above, there have been proposed various types of the endless belt for the electrophotographic device, which have high degrees of surface flexibility and wear resistance, as disclosed in JP-A-2005-25052, JP-A-2001-347593, and Japanese Patent No. 3969080. However, an extensive study by the present inventors of the endless belts disclosed in those patent documents and other conventional endless belts reveals that the endless belts having the elastic layer which is formed on the base layer and which has a large content of the inorganic filler, in particular, do not really have a sufficiently high degree of wear resistance in their surface portion (in the surface portion of their elastic layer).

### SUMMARY OF THE INVENTION

The present invention has been made in the light of the situations described above. It is therefore an object of the present invention to provide an endless belt for an electrophotographic device, which has an elastic layer formed on a surface of a base layer and including a large content of an inorganic filler, and which has high degrees of flexibility and wear resistance in its surface portion (in its elastic layer).

The object indicated above can be achieved according to the principle of this invention, which provides an endless belt for an electrophotographic device, comprising a base layer, and an elastic layer formed on a surface of the base layer, by using a rubber composition including at least one rubber material and at least one inorganic filler, wherein the elastic layer having 40-75% by mass of a total organic component, and a product P of an indentation Young's modulus (MPa) a and a fracture strain (%) β is within a range of 6000-50000.

In a first preferred form of the endless belt of the present invention, the indentation Young's modulus is within a range of 4-150 MPa.

In a second preferred form of the endless belt of the present invention, the fracture strain is within a range of 40-1500%.

In a third preferred form of the endless belt of this invention, the at least one rubber material is selected from a group consisting of NBR, BR, SBR, IIR and CR.

In a fourth preferred form of the endless belt of this invention, the rubber composition includes a resinous cross-linking agent.

In a fifth preferred form of the endless belt of this invention, the at least one inorganic filler includes at least an inorganic fire-resistant agent.

In a sixth preferred form of the endless belt of the present invention, the elastic layer is formed by a dispenser coating method.

In a seventh preferred form of the endless belt of this invention, the base layer is formed of a polyimide resin or a polyamideimide resin.

The endless belt for the electrophotographic device of the present invention described above comprises the base layer, and the elastic layer which is formed on a surface of the base layer, by using the rubber composition including at least one rubber material and at least one inorganic filler, and which is characterized by 1) 40-75% by mass of a total organic component, and 2) the product of the indentation Young's modulus (MPa) α and the fracture strain (%) β which is within the range of 6000-50000. The endless belt of this invention provides various advantages owing to the inclusion of the at least one inorganic filler to the elastic layer, more specifically, not only improvements of formability and fire resistance, and reduction of the cost of manufacture, but also improvements of flexibility and wear resistance in a surface portion of the elastic layer, permitting the use of the endless belt as an intermediate image transfer belt of the electrophotographic device for a long period of time, while effectively preventing superficial wearing or removal of the elastic layer in its local areas corresponding to the edge or end portions of a recording medium (such as a sheet of paper) to which an image is transferred from the intermediate image transfer belt, whereby the endless belt is given a longer service life as compared with the conventional endless belt.

### BRIEF DESCRIPTION OF THE DRAWINGS

The above and other objects, features, advantages and technical and industrial significance of the present invention will be better understood by reading the following detailed description of the present invention, when considered in connection with the accompanying drawings, in which:

FIG. 1 is a cross sectional view showing one example of an endless belt for an electrophotographic device of the present invention;

FIG. 2 is a fragmentary cross sectional view showing the endless belt of the present invention;

FIG. 3 is a schematic and fragmentary view of one example of an image transfer mechanism of the electrophotographic device, which is provided with the endless belt in the form of an intermediate image transfer belt; and

FIG. 4 is a view showing one example of a dispenser coating method of manufacturing the endless belt of the present invention.

### DETAILED DESCRIPTION OF THE INVENTION

Referring to the drawings, the present invention will be described in more detail.

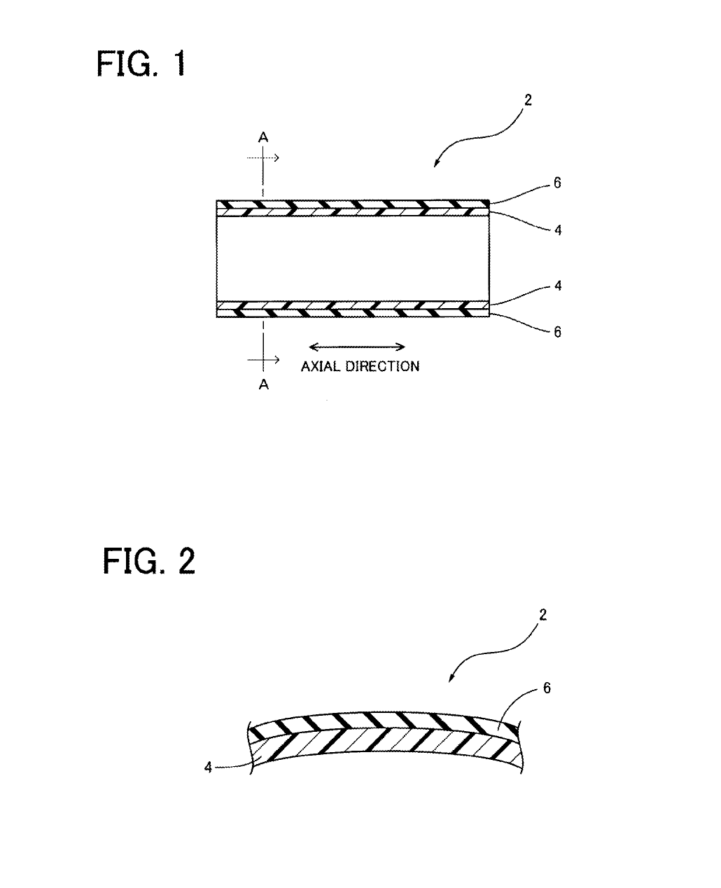

One example of an endless belt for an electrophotographic device is shown in the cross sectional view of FIG. 1 taken in a plane which is parallel to an axis of rotation of the endless belt and which includes the axis of rotation, and is also shown in the fragmentary cross sectional view of FIG. 2 taken in a plane perpendicular to the axis of rotation (taken along line A-A of FIG. 1). As shown in FIGS. 1 and 2, the endless belt denoted by reference sign 2 has a two-layered structure consisting of a base layer 4 and an elastic layer 6 formed on a surface of the base layer 4.

The base layer 4 is formed according to various methods known in the art, by using a base layer composition including at least one rubber material and at least one synthetic resin material as major components. The rubber and synthetic resin materials that can be used as the major components of the base layer composition are selected from those materials conventionally used for manufacturing endless belts for electrophotographic devices. For improving the durability of the belt 2, the synthetic resin materials are preferably used. For example, the following synthetic resin materials are used alone or in combination: polyimide resin; polyamideimide resin; polyether sulfone resin; fluororesin; and polycarbonate resin. In the present invention, polyimide resin and polyamideimide resin are particularly preferably used for assuring a sufficiently high degree of rigidity of the base layer 4.

The base layer composition may further include additives such as electrically conductive agents, fire-resistant agents, calcium carbonate or other fillers, and leveling agents, in addition to the above-described rubber materials and/or synthetic resin materials, as needed and to an extent not hindering the object of the present invention.

The electrically conductive agents that can be added to the base layer composition are not particularly limited, and may include: electrically conductive powders such as carbon black and graphite; metallic powders such as aluminum powder and stainless steel powder; electrically conductive metal oxides such as electrically conductive zinc oxide (c-ZnO), electrically conductive titanium oxide (c-TiO₂), electrically conductive iron oxide (c-Fe₃O₄), and electrically conductive tin oxide (c-SnO₂); and ion conductive agents such as quaternary ammonium salt, phosphoric acid ester, sulfonate, fatty polyhydric alcohol, and fatty alcohol sulfate. Further, examples of fire-resistant agents that can be added to the base layer composition include inorganic fire-resistant agent and organic fire-resistant agent, which will be described later.

The method of preparing the base layer composition including the above-described synthetic resin material(s) is determined depending on the method of manufacturing the belt 2. Where the base layer 4 is formed according to a dispenser coating method described below, for example, the base layer composition in a liquid state is prepared by adding and mixing the above-described synthetic resin material(s) and other materials to and with an organic solvent such as N-methyl-2-pyrrolidone (NMP), dimethylformamide (DMF), dimethylacetoamide (DMAc), toluene and acetone. Where the base layer 4 is formed by using this base layer composition in the liquid state according to the dispenser coating method (see FIG. 4), the base layer composition is prepared to have a viscosity of 50-50000 mPa·s.

The thickness of the base layer 4 formed from the above-described base layer composition is selected suitably depending on the required properties of the endless belt 2 for the electrophotographic device, generally within a range of about 50-200 μm.

The endless belt 2 for the electrophotographic device of the present invention as shown in FIGS. 1 and 2 is characterized by the elastic layer 6 formed on a surface of the above-described base layer 4, by using a rubber composition including at least one rubber material and at least one inorganic filler. This elastic layer 6 has 40-75% by mass of a total organic component, and a product P of an indentation Young's modulus (MPa) α and a fracture strain (%) β is within a range of 6000-50000.

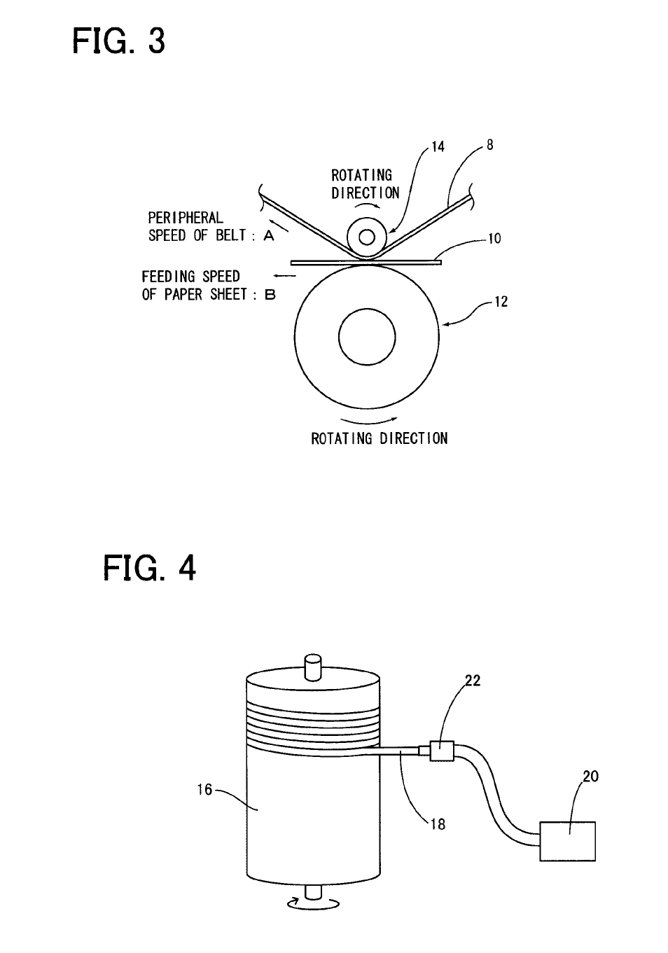

The foregoing description explains in detail how the object of the present invention can be achieved by selecting the product P of the indentation Young's modulus (MPa) α and the fracture strain (%) β, within the predetermined suitable range of 6000-50000. Referring to the fragmentary and schematic view of FIG. 3, there is shown one example of an image transfer mechanism of the electrophotographic device, which is provided with the endless belt in the form of an intermediate image transfer belt 8 from which a toner image is transferred to a recording medium such as a sheet of paper 10. The endless intermediate image transfer belt 8 is rotated by suitable driving means (not shown) at a predetermined peripheral speed A as indicated in FIG. 3, while the paper sheet 10 is fed by feeding means (not shown) at a predetermined feeding speed B as also indicated in FIG. 3. For partial contact of the intermediate image transfer belt 8 and the paper sheet 10 with each other so that the intermediate image transfer belt 8 is pressed against the paper sheet 10 in the mutually contacting area, the intermediate image transfer belt 8 and the paper sheet 10 are passed through a nip between a transfer roll 12 and a backup roll 14. The toner image formed on the intermediate image transfer belt 8 is moved at the peripheral speed A while the paper sheet 10 is fed at the feeding speed B, so that the toner image is transferred from the intermediate image transfer belt 8 onto the paper sheet 10, in the mutually contacting area.

The image transfer mechanism shown in FIG. 3 is configured such that the feeding speed B of the paper sheet 10 is higher than the peripheral speed A of the intermediate transfer roll 8, namely, B>A, for the purpose of effectively transferring the toner image from the intermediate transfer roll 8 onto the paper sheet 10. Accordingly, a tensile force is applied to the intermediate image transfer belt 8 in its rotating direction due to the feeding movement of the paper sheet 10 at the feeding speed B higher than the peripheral speed A, in the area of contact of the intermediate image transfer belt 8 with the paper sheet 10, while at the same time a pressing force is applied to the area of contact of the intermediate image transfer belt 8 with the paper sheet 10, in the direction of thickness of the intermediate image transfer belt 8 (in the vertical direction as seen in FIG. 3), by the backup roll 14 (and the transfer roll 12 via the paper sheet 10). The present inventors recognized this fact that the intermediate transfer roll 8 is subjected to a load in the direction of thickness and another load in the rotating direction, during the transfer of the toner image from the intermediate transfer roll 8 onto the paper sheet 10, and an extensive study by the present inventors based on this recognition revealed that specimens of the intermediate image transfer belt 8 the elastic layer of which has 40-75% by mass of a total organic component exhibit sufficiently high degrees of flexibility and wear resistance in the surface portion of the intermediate image transfer belt (in the surface portion of the elastic layer), where the product P of the indentation Young's modulus (MPa) α and the fracture strain (%) β falls within a range of 6000-50000. Thus, the present invention was made on the basis of the above-described recognition and extensive study.

In this specification and claims, the “percent by mass of a total organic component” is obtained through measurement with respect to the elastic layer (6) of the cross-linked rubber, in accordance with JIS-K-6226-1: 2003, or JIS-K-6226-2: 2003 of the Japanese Industrial Standards. In the present invention, the elastic layer (6) having less than 40% by mass of the total organic component is considered to have a risk of failure to obtain effectively high advantages owing to the inclusion of the inorganic filler, such as improved formability and fire resistance. Further, the elastic layer (6) having more than 75% by mass of the total organic component is considered to have a risk of deterioration of compatibility with the paper sheet due to an excessively high hardness of the elastic layer (6), in the case (I) where the total organic component includes an excessively large content of a cross-linking agent, and a risk of failure of formation as a layer due to an excessively low hardness, in the case (II) where the total organic component includes an excessively large content of a softening agent.

Further, in the present invention, the surface portion of the endless belt (surface portion of the elastic layer 6) in its local areas corresponding to the edge or end portions of the recording medium (paper sheet 10) is considered to have a risk of superficial removal due to wearing by repeated passages of the recording medium through the image transfer mechanism for a long period of time, where the product P of the indentation Young's modulus α and the fracture strain (%) β is less than 6000. Furthermore, there is a risk of difficulty to form the endless belt where the product P is more than 50000.

Although the object of this invention can be achieved as long as the product P of the indentation Young's modulus α and the fracture strain (%) β of the elastic layer (6) is within the range of 6000-50000, the elastic layer (6) is considered to have a risk of an excessively low hardness and an excessively high degree of tackiness, causing deterioration of the image quality due to deterioration of ease of cleaning of the elastic layer, where the indentation Young's modulus α is excessively low, and a risk of an excessively high hardness and consequent deterioration of compatibility with the paper sheet, where the indentation Young's modulus α is excessively high. Further, the elastic layer (6) is considered to have a risk of an excessively high degree of brittleness and consequent easy cracking, causing shortening of the service life, where the fracture strain β is excessively small, and a risk of an excessively low hardness and an excessively high degree of tackiness, causing deterioration of the image quality due to deterioration of ease of cleaning of the elastic layer, where the fracture strain β is excessively large. Therefore, in the endless belt for the electrophotographic device of the present invention, the indentation Young's modulus α of the elastic layer (6) is preferably within a range of 4-150 MPa, while the fracture strain β of the elastic layer (6) is preferably within a range of 40-1500%.

The indentation Young's modulus α of the elastic layer (6) was obtained by manufacturing specimens (having a thickness of 200 μm) using a rubber composition for the elastic layer, subjecting these specimens to an indentation test in accordance with ISO 14577-1 “Metallic Materials-Indentation Test for Hardness and material parameters, Part 1: Test Method”, and calculating the indentation Young's modulus α on the basis of the test results, in accordance with Appendix “A.5 Indentation Modulus of Elasticity E_{IT}” attached to ISO 14577-1. The fracture strain β of the elastic layer (6) was measured by manufacturing specimens (having a thickness of 200 μm) using the rubber composition for the elastic layer, and subjecting these specimens to a tensile test in accordance with JIS-K-6251.

For forming the above-described elastic layer 6 on the surface of the base layer 4, the rubber composition including at least one rubber material, at least one inorganic filler, and various additives as needed is prepared.

The rubber material(s) can be suitably selected from among the various known rubber materials, to manufacture the desired endless belt for the electrophotographic device. Preferably, the at least one rubber material is selected from a group consisting of acrylonitrile-butadiene rubber (NBR), butadiene rubber (BR), styrene-butadiene rubber (SBR), butyl rubber (IIR) and chloroprene rubber (CR). These rubber materials may be used alone or in combination.

The inorganic filler(s) to be mixed with the rubber material(s) can be suitably selected from inorganic powders which are conventionally used for improving the properties of the rubber composition and increasing the volume of the rubber composition and which do not hinder the object of the present invention. In this invention, the inorganic filler(s) is preferably selected from among silica (silicon oxide), titanium oxide, zinc oxide, talc, various kinds of ceramics, glass beads, mica, and inorganic fire-resistant agents. Specifically, the inorganic fire-resistant agents may be selected from among antimony-based fire-resistant agents such as antimony trioxide and antimony pentoxide, and metal hydroxide-based fire-resistant agents such as aluminum hydroxide and magnesium hydroxide. In the present invention, the inorganic filler(s) preferably includes at least one inorganic fire-resistant agent, namely, consists of at least one inorganic fire-resistant agent, or includes a combination of at least one inorganic fire-resistant agent and other inorganic filler material or materials such as silica.

The rubber composition used in the present invention may further include various additives conventionally used for manufacturing endless belts for electrophotographic devices, in addition to the above-described rubber material(s) and inorganic filler(s). More specifically, the rubber composition may include at least one cross-linking agent and at least one electrically conductive material, as long as these additives do not hinder the object of this invention.

The cross-linking agent(s) may be selected from among metal oxides such as zinc flower (zinc oxide) and magnesium oxide, various kinds of sulfur, and resinous cross-linking agents. The various kinds of sulfur may be selected from among powdered sulfur, precipitated sulfur, colloid sulfur, insoluble sulfur, high-dispersion sulfur, and halogenated sulfurs such as sulfur monochloride and sulfur dichloride. The resinous cross-linking agents may be selected from among phenol resin, epoxy resin, amino resin, isocyanate resin, guanamine resin, unsaturated polyester resin, diarylphtalate resin, phenoxy resin, urethane resin and polyurea resin. Preferably, the resinous cross-linking agents are used in the present invention, owing to their effect to facilitate the control of the cross-linking speed, and their effect to improve the chronological stability of the rubber composition.

The phenol resin usable as the resinous cross-linking agents may be selected from among novolak type phenol resin, resol type phenol resin, and resol type xylene resin.

The epoxy resin usable as the resinous cross-linking agents may be selected from among bisphenol A type glycidyl ether, bisphenol type glycidyl ether, novolak type glycidyl ether, polyethylene glycol type glycidyl ether, polypropylene glycol type glycidyl ether, glycerin type glycidyl ether, aromatic type glycidyl ether, aromatic type glycidyl amine, phenol type glycidyl amine, hydrophthalate type glycidyl ester, and dimmer acid type glycidyl ester.

The amine resin is interpreted to collectively mean thermosetting resins obtained by adding formaldehyde to a compound having an amino group such as urea, melamine, benzoguanamine and aniline, for condensing the compound. The amine resin used as the resinous cross-linking agent in this invention may be selected from among urea resin, melamine resin, methylolmelamine resin, benzoguanamine resin, aniline resin, acetoguanamine resin, formguanamine resin and methylolguanamine resin.

The isocyanate resin usable as the resinous cross-linking agent may be selected from among: tolylene diisocyanate (TDI); diphenylmethane diisocyanate (MDI); hexamethylene diisocyanate (HDI); isophorone diisocyanate (IPDI); burette type, isocyanurate type, trimethylol propane-modified type of those isocyanate resins; and block types of those isocyanate resin types.

The rubber composition for forming the elastic layer generally includes an electrically conductive agent for giving the endless belt 2 electric conductivity. The electrically conductive agent may be selected from among not only conventionally used carbon blacks and metal oxides, but also ion conductive agents such as quaternary ammonium salt, phosphoric acid ester, sulfonic acid salt, fatty polyalcohol, and fatty alcohol sulfate salt. Particularly, the ion conductive agents are preferably used.

Further, the rubber composition preferably includes at least one organic fire-resistant agent, in view of a recent need for increased fire resistance of the endless belt for the electrophotographic device. In the present invention, the organic fire-resistant agent(s) may be selected from among, for example: a) decabromodiphenyl ether; b) tetrabromobisphenol-A and its derivative; c) multi-benzene-ring compound such as bis(pentabromophenyl)ethane; d) bromine-based fire-resistant agent such as brominated polystylene and polybrominated stylene; e) aromatic phosphoric acid ester; f) aromatic condensed phosphoric acid ester; g) halogen-contained phosphoric acid ester; h) halogen-contained condensed phosphoric acid ester; and i) phosphor-based fire-resistant agent such as phosphazine derivative. These organic fire-resistant agents may be used alone or in combination. Further, these organic fire-resistant agents may be used together with the inorganic fire-resistant agent(s) serving as the inorganic filler(s).

The material for the elastic layer may further include any other additives such as a leveling agent and a cross-linking promoting agent, within the scope of this invention.

The leveling agent usable in the present invention may be a silicone-based leveling agent or an acrylic-based leveling agent. Described more specifically, the silicone-based leveling agent may be organic modified polysiloxane such as polydimethyl siloxane as a typical example. The organic modification may be polyether modification, polyester modification, or aralkyl modification having a benzene ring. The acrylic-based leveling agent may have polyacrylate as a basic skeleton modified by alkyl, perfluoroalkyl, polyester or polyether, for example.

The cross-linking promoting agent usable in the present invention may be selected from among: sulfonamide-based cross-linking promoting agent such as N-cyclohexyl-2-benzothiazole sulfenamide, N-t-butyl-2-benzothiazole sulfenamide, N-oxyethylene-2-benzothiazole sulfenamide, N-oxymethylene-2-benzothiazole sulfenamide, and N,N′-diisopropyl-2-benzothiazole sulfenamide; guanidine-based cross-linking promoting agent such as diphenylguanidine, diorthotolylguanidine, and orthotolylbiguanidine; thiourea-based cross-linking promoting agent such as thiocarboanilide, diorthotolylthiourea, ethylenethiourea, diethylthiourea, and trimethylthiourea; thiazole-based cross-linking promoting agent such as 2-mercaptobenzothiazole, dibenzothiazyldisulfide, 2-mercaptobenzothiazole zinc salt, 2-mercaptobenzothiazole sodium salt, 2-mercaptobenzothiazole cyclohexylamine salt, and 2-(2,4-dinitrophenylthio)benzothiazole; thiuram-based cross-linking promoting agent such as tetramethylthiuram monosulfide, tetramethylthiuram disulfide, tetraethylthiuram disulfide, tetrabutylthiuram disulfide, and dipentamethylenethiuram tetrasulfide; dithiocarbamic-acid-based cross-linking promoting agent such as sodium dimethylthiocarbamate, sodium diethylthiocarbamate, sodium di-n-butyldithiocarbamate, lead dimethyldithiocarbamate, zinc dimethyldithiocarbamate, zinc diethyldithiocarbamate, zinc di-n-butyldithiocarbamate, zinc pentamethylenedithiocarbamate, zinc ethylphenyldithiocarbamate, tellurium diethyldithiocarbamate, selenium dimethyldithiocarbamate, selenium diethyldithiocarbamate, copper dimethyldithiocarbamate, iron dimethyldithiocarbamate, diethylamine diethyldithiocarbamate, piperidine pentamethylenedithiocarbamate, and pipecoline methylpentamethylenedithiocarbamate; and xanthic-acid-based cross-linking promoting agent such as sodium isopropylxanthate, zinc isokpropylxanthate, and zinc butylxanthate.

The method of preparing the above-described rubber composition is suitably determined depending on the method of manufacture of the endless belt 2. Where, the elastic layer 6 is formed according to the dispenser coating method described below, the rubber material(s) and the other components of the rubber composition are added to and mixed with an organic solvent such as N-methyl-2-pyrrolidone (NMP), dimethylformamide (DMF), dimethylacetoamide (DMAc), toluene or acetone, to prepare the rubber composition in a liquid state. Where the elastic layer 6 is formed according to the dispenser coating method by using the thus prepared rubber composition in the liquid state, the viscosity of the liquid rubber composition is adjusted to fall within a range of 50-50000 mPa·s.

While each of the base layer 4 and the elastic layer 6 of the endless belt 2 for the electrophotographic device of the present invention may be formed according to any one of the methods known in the art, the base layer 4 and the elastic layer 6 are preferably formed according to the dispenser coating method described below. The manufacture of the endless belt 2 according to the dispenser coating method will be described in detail.

Initially, a dispenser is provided which has a hollow or solid cylindrical substrate body rotatable about its axis, two nozzles (first and second nozzles) and two material tanks (first and second material tanks). The first and second nozzles are disposed near the outer circumferential surface of the substrate body such that the two nozzles are moved in an axial direction of the substrate body. Meanwhile, the material in the liquid state for the base layer 4, and the rubber composition in the liquid state for the elastic layer 6 are prepared, and are accommodated in the first and second material tanks, respectively. The substrate body has an outside diameter determined depending upon the specifications of the endless belt 2 to be manufactured. Generally, the outside diameter of the substrate body is selected within a range of 30-1000 mm. The first and second nozzles have a diameter generally selected within a range of 0.5-2.0 mm.

Referring next to FIG. 4, the substrate body 16 in the form of a hollow cylindrical body is placed upright, and the substrate body 16 is rotated about its vertically extending axis. While the substrate body 16 is rotated, the base layer material 18 accommodated in the first material tank 20 is fed to the first nozzle 22, and is ejected from this first nozzle 22 onto the outer circumferential surface of the substrate body 16. While the base layer material 18 is ejected, the first nozzle 22 is moved at a predetermined constant speed in the axial direction of the substrate body 16, so that a strip (elongate film) of the base layer material 18 having a predetermined width is formed helically on the outer circumferential surface of the substrate body 16. Thus, a circumferential film of the base layer material 18 is formed by helical turns of the continuous strip of the base layer material 18 on the circumferential surface of the substrate body 16 during the movement of the first nozzle 22 from its position corresponding to one of opposite axial ends of the substrate body 16 to its position corresponding to the other axial end of the substrate body 16. Generally, the helical continuous strip of the base layer material 18 is formed on the outer circumferential surface of the substrate body 16 such that an upper one of the two adjacent helical turns of the strip is spaced apart by a predetermined suitable gap from a lower one of the two adjacent helical turns.

The circumferential film of the base layer material 18 thus formed on the outer circumferential surface of the substrate body 16 is then subjected to a heat treatment under a predetermined condition, so as to remove the solvent, whereby the base layer 4 is initially formed.

Subsequently, the substrate body 16 having the base layer 4 formed on its outer circumferential surface is rotated about its axis as described above by reference to FIG. 4, and the rubber composition for the elastic layer 6 accommodated in the second material tank is fed to the second nozzle disposed near the outer circumferential surface of the substrate body 16 (near the base layer 4 formed thereon), and is ejected from this second nozzle onto the base layer 4 on the outer circumferential surface of the substrate body 16. While the rubber composition is ejected, the second nozzle is moved at a predetermined constant speed in the axial direction of the substrate body 16, so that a strip (elongate film) of the liquid rubber composition having a predetermined width is formed helically on the outer circumferential surface of the base layer 4. Thus, a circumferential film of the rubber composition is formed by the helical continuous strip of the rubber composition on the circumferential surface of the base layer 4 during the movement of the second nozzle from its position corresponding to one axial end of the substrate body 16 to its position corresponding to the other axial end of the substrate body 16. It is noted that the endless belt 2 of the present invention has a risk of failure to exhibit an advantage (a sufficiently high degree of flexibility in its surface portion) owing to the provision of the elastic layer 6, if the thickness of the elastic layer 6 is excessively small, and the heat treatment requires a long length of time if the thickness is excessively large. In this respect, the circumferential film of the rubber composition is formed such that the thickness of the elastic layer 6 is held within a range of 50-1000 μm in the present invention.

The circumferential film of the rubber composition thus formed is then subjected to a cross-linking treatment (heat treatment) depending upon the specific rubber material and the cross-linking agent of the rubber composition, whereby the endless belt 2 consisting of the base layer 4 and the elastic layer 6 formed on the surface of the base layer 4 is obtained.

Various conditions for forming the base layer 4 and the elastic layer 6 according to the dispenser coating method described above, more specifically, a rotating speed of the substrate body 16, a moving speed of the first and second nozzles, amounts of ejection of the first and second materials and other conditions are selected depending upon the specific first and second materials used for the respective base layer 4 and elastic layer 6.

While the dispenser coating method described above may use a solid cylindrical substrate body rather than the hollow cylindrical substrate body 16, the use of a hollow cylindrical substrate body is preferred for reduction of a load of driving means for rotating the substrate body. In this respect, a drum formed of iron, aluminum, stainless steel or any other suitable metal is preferably used.

The first and second nozzles for ejecting the first and second materials for forming the base and elastic layers are preferably needle nozzles, and may take a round, plane or rectangular form.

The endless belt 2 for the electrophotographic device, which is manufactured as described above, is configured to exhibit sufficiently high degrees of flexibility and wear resistance in its surface portion (in the surface portion of the elastic layer), effectively preventing wearing (removal) in the local areas of its surface portion (in the surface portion of its elastic layer) corresponding to the edge or end portions of the recording medium (e.g., paper sheet) where the endless belt 2 is used as an intermediate image transfer belt for a long period of time, as well as to have various advantages (e.g., easy formability, improved fire resistance, and reduced cost of manufacture) owing to the inclusion of the inorganic filler in the elastic layer.

While the typical embodiment of this invention has been descried in detail, it is to be understood that the endless belt for an electrophotographic device according to the present invention is not limited to the details of the embodiment described above.

For instance, the surface (surface of the elastic layer 6) of the endless belt 2 consisting of the base layer 4 and the elastic layer 6 manufactured as descried above may be subjected to a suitable surface treatment for the purpose of improving its resistance to the toner adhering to its surface where the endless belt 2 is used as an intermediate image transfer belt. Examples of the surface treatment include a chloride treatment using a chlorinated compound, a fluorine.chloride treatment using a fluorinated and chlorinated compound, an isocyanate treatment using isocyanate, or a UV treatment using a ultraviolet radiation. These surface treatment methods are known in the art.

### Examples

Some examples of this invention will be described to further clarify the present invention. However, it is to be understood that the present invention is not limited to the details of these illustrated example, and that the invention may be embodied with various changes, modifications or improvements, which may occur to those skilled in the art, without departing from the spirit of this invention.

### —Preparation of Base Layer Material—

Initially, RIKACOAT EN-20 (trade name) available from New Japan Chemical Co., Ltd. was provided as a polyimide resin (PI), and VYLOMAX HR-16NN (trade name) available from Toyobo Co., Ltd. was provided as a polyamideimide resin (PAI). Then, 100 parts by weight of each of the polyimide resin and polyamideimide resin, and 10 parts by weight of carbon black were added to and mixed with 800 parts by weight of N-methyl-2-pyrrolidone (NMP), to prepare two kinds of the liquid base layer material. “PI” and “PAI” in Tables 1-3 below respectively represent the polyimide resin and the polyamideimide resin which were used in Examples and Comparative Examples.

### —Preparation of Rubber Composition (Elastic Layer Material)—

Components indicated in Tables 1 and 2 were added to and mixed with a suitable amount of cyclohexanone, by parts by weight indicated in the tables, to prepare a plurality of kinds of the liquid rubber composition (elastic layer material). The components used to prepare the rubber composition are as follows:
Acrylonitrile-butadiene rubber (NBR)
   NIPOLE DN101 (trade name) available from ZEON CORPORATION
Butadiene rubber (BR)
   NIPOLE BR1220 (trade name) available from ZEON CORPORATION
Styrene-butadiene rubber (SBR)
   TUFDENE 1000 (trade name) available from Asahi Kasei Corporation
Butyl rubber (IIR)
   JSR BUTYL 365 (trade name) available from JSR Corporation
Chloroprene rubber (CR)
   DENKA CHLOROPRENE DCR-75 (trade name) available from DENKI KAGAKU KABUSHIKI KAISHA
Crosslinking agent I (phenol resin)
   SUMILITE RESIN PR-11078 (trade name) available from SUMITOMO BAKELITE CO., LTD
Crosslinking agent II (epoxy resin)
   DENACOL EX-622 (trade name) available from Nagase Chemtex Corporation
Crosslinking agent III (melamine resin)
   SUPER BECKAMINE J-820-60 (trade name) available from DIC Corporation
Crosslinking agent IV (isocyanate resin)
   DURANATE E402-B80T (trade name) available from ASAHI KASEI CHEMICALS CORPORATION
Inorganic fire-resistant agent A: APYRAL (trade name) available from Nabaltec AG (Germany)
Inorganic fire-resistant agent B: Magnifin (trade name) available from ALBEMARLE JAPAN CORPORATION
Organic fire-resistant agent
   Phosphazene derivative, Rabitle FP-110 (trade name) available from FUSHIMI Pharmaceutical Co., Ltd.
   Ion conductive agent: quaternary ammonium salt (Tetrabutylammonium Hydrogenfulfate, TBAHS) available from Wako Pure Chemical Industries, Ltd.

### —Manufacture of Endless Belt—

A hollow cylindrical body of aluminum was provided as the substrate body, and a dispenser having two nozzles was provided as a device for ejecting a liquid at a constant rate. Each of the nozzles of this dispenser is a needle nozzle having an inside diameter of 1 mm. Then, the liquid base layer material and rubber composition were accommodated in separate air-pressurized tanks, and the substrate body and the two nozzles were positioned such that the nozzles had a clearance of 1 mm with respect to the outer circumferential surface of the substrate body. The nozzle for ejecting the base layer material was moved at a speed of 1 mm/sec in the vertical direction while the substrate body disposed upright with its axis extending in the vertical direction was rotated about its axis at a speed of 200 rpm, and the air-pressurized tank accommodating the base layer material was pressurized at 0.4 MPa to feed the base layer material to the nozzle, for ejecting the base layer material from the nozzle onto the outer circumferential surface of the substrate body, such that a strip of the base layer material was helically formed such that a circumferential film of the base layer material was formed by the helical turns of the continuous strip as shown in FIG. 4. The circumferential film thus formed had a thickness of 80 μm. The circumferential film was subjected to a heat treatment wherein the circumferential film was heated from the ambient temperature to 250° C. for two hours, and kept at 250° C. for one hour, whereby the base layer was formed on the outer circumferential surface of the substrate body.

Then, the nozzle for ejecting the liquid rubber composition was moved at a speed of 1 mm/sec in the vertical direction while the substrate body on which the base layer was formed as described above was rotated about its axis at a speed of 200 rpm and the air-pressurized tank accommodating the rubber composition was pressurized at 0.8 MPa to feed the rubber composition to the nozzle, for ejecting the rubber composition from the nozzle onto the outer circumferential surface of the base layer on the outer circumferential surface of the substrate body, such that a strip of the rubber composition was helically formed such that a circumferential film of the rubber composition was formed by the helical turns of the continuous strip. The circumferential film thus formed had a thickness of 200 μm. The circumferential film was subjected to a heat treatment wherein the circumferential film was heated from the ambient temperature to 170° C. for three hours, and kept at 170° C. for 0.5 hour, whereby an endless belt consisting of the base layer and the elastic layer formed on the base layer was fabricated on the outer circumferential surface of the substrate body. In this respect, it is noted that an endless belt consisting of the base and elastic layers formed integrally with each other could not be obtained in Comparative Example 6.

### —Surface Treatment of Elastic Layer—

The elastic layers of the endless belts in Examples 1-4 and 6-15 and Comparative Examples 1-5 were subjected to a surface treatment in the following manner. Initially, the following components were added by parts by weight indicated below to a mixture solvent of ethyl acetate and tertiary butyl alcohol (TBA) [ethyl acetate:TBA=9:1 (weight ratio)], to prepare a surface treatment liquid A (solid portion: 2%) and a surface treatment liquid B (solid portion 2%):

### [Surface Treatment A]

[Surface Treatment A]

| | |
|---|---|
| Hypochlorous acid t-butyle | 2 parts by weight |
| Ethyl acetate | 9.8 parts by weight |
| Tertiary butyl alcohol | 88.2 parts by weight |

[Surface Treatment Liquid B]

| | |
|---|---|
| Boron trifluoride-diethyl ether complex | 2 parts by weight |
| Ethyl acetate | 9.8 parts by weight |
| Tertiary butyl alcohol | 88.2 parts by weight |

The surfaces of the endless belts were subjected to a roller coating operation for 30 seconds in the atmosphere at the room temperature, by using a mixture of the surface treatment liquid A and the surface treatment liquid B (mixing ratio of 1:1 by weight) in Examples 1-3 and 6-15 and Comparative Examples 1-5, and by using only the surface treatment liquid A in Example 4. Subsequently, the surfaces of the endless belts were washed by water, and water drops were removed from the surfaces by air blows. “F.Cl” in Tables 1 and 2 below represents the surface treatment using the mixture of the surface treatment liquids A and B, while “Cl” in the table represents the surface treatment using only the surface treatment liquid A.

The elastic layer of the endless belt in Example 5 was subjected to a UV treatment. Described in detail, the surface of the endless belt (surface of the elastic layer) without the surface treatment was subjected to a surface treatment by irradiation with a ultraviolet radiation for 30 seconds by a ultraviolet irradiator UB031-2A/BM (trade name: mercury lamp type) available from EYE GRAPHICS CO., LTD, at an irradiation intensity of 120 mW/cm², with a distance of 40 mm between the light source of the ultraviolet irradiating device and the surface of the elastic layer, while the endless belt was rotated at a peripheral speed of 570-590 mm/sec.

The properties of the thus obtained endless belts for the electrophotographic device were measured or evaluated in the following manner. The measurements (calculations) of the “percent by mass of total organic component”, “indentation Young's modulus: α” and “fracture strain: β” which will be described were made with respect to specimens of the rubber compositions for the elastic layer of the each endless belts, which were cross-linked under the same conditions as used for the manufacture of the endless belts.

### —Total Organic Component Mass Percent of Elastic Layer—

The percent by mass of the total organic component of the elastic layer of each specimen was calculated by a thermogravimetric analyzer TGA-50H (trade name) available from SHIMADZU CORPORATION, on the basis of the weight of the total organic component measured in accordance with JIS-K-6226-1: 2003, or JIS-K-6226-2: 2003, and the weight of the specimen.

Weight of the total organic component
=weight of the specimen−weight of ash content (−weight of carbon black*) *The weight of the carbon black was detected only if the carbon black was included in the specimen.
   Mass percent of the total organic component
=[weight of the total organic component/specimen weight]×100(%)

### —Indentation Young's Modulus α of Elastic Layer—

The indentation Young's modulus α of each specimen having a thickness of 200 μm was measured by conducting an indentation test of the specimen in accordance with ISO 14577-1 “Metallic Materials-Indentation Test for Hardness and material parameters, Part 1: Test Method”, and calculating the indentation Young's modulus α on the basis of the test result, in accordance with Appendix “A.5 Indentation Modulus of Elasticity E_{IT}” attached to ISO 14577-1. Described in detail, the indentation Young's modulus α was measured by conducting 30 μm constant indentation displacement of the elastic layer with a Vickers hardness presser, using a microhardness tester HM2000LT (trade name) available from Fischer Instruments K.K. This measurement was made five times for each endless belt, and an average value of the five measurements was calculated. The average values of the specimens are indicated in Tables 1-3.

### —Fracture Strain β of Elastic Layer—

The fracture strain β of each specimen having a thickness of 200 μm was measured by conducting a tensile test of the specimen in accordance with JIS-K-6251.

The product P of the measured indentation Young's modulus and fracture strain was calculated. The calculated products P of the specimens are indicated in Tables 1-3.

### —Simplified Wear Test—

The endless belt of each specimen was pressed with a suitable force against a surface of a sheet of paper wound on the outer circumferential surface of a rotatable roll having a diameter of 14 mm. In this condition, the roller was rotated at about 2300 rpm for 15 seconds. Then, the local areas of the surface of the endless belt corresponding to the edge portions of the paper sheet were observed by a laser microscope, to detect a thickness of removal of the local areas due to contact with the edge portions of the paper sheet. The thickness of removal is a maximum depth of removed parts with respect to the non-removed flat part after smoothing compensation. The thus obtained thickness values of removal of the specimens are indicated in Tables 1-3.

### —Durability Test of Endless Belt Built in Printer—

The specimens of the endless belt were built as an intermediate image transfer belt in a multi-function printer “bizhub C550” available from KONICA MINOLTA HOLDING, INC., and the printer was operated under temperature and humidity conditions of 23.5° C.×53% RH, to perform a test-pattern printing operation on a total of 200000 sheets of paper of A4 size. After the test-pattern printing operation, the endless belt was removed from the printer, and the local areas of the surface of the endless belt corresponding to the edge portions of the paper sheets were visually inspected to detect removal (wear) of the local areas. “GOOD” and “POOR” in Tables 1-3 respectively indicate the absence and presence of the removal (wear) of the local areas of the endless belt.

### —Fire Resistance—

The specimens were subjected to a VTM fire resistance test in accordance with UL Standards 94 (Chapter 11, Fifth edition) of Underwriters Laboratories Inc, USA. Results of evaluation of the fire resistance of the specimens based on this test are indicated in Tables 1-3. It will be understood from Table 4 indicating degrees VTM-0, VTM-1 and VTM-2 of the fire resistance, that VTM-0 represents the highest degree of the fire resistance, and VTM-1 represents the next highest degree of the fire resistance, while VTM-2 and VTM-n (n>2) represent the unacceptably low degree of the fire resistance, which is indicated by “not” in Table 3.

TABLE 1

| | | EXAMPLES | | | | | | | | | | | |
|---|---|---|---|---|---|---|---|---|---|---|---|---|---|
| | | 1 | 2 | 3 | 4 | 5 | 6 | 7 | 8 | 9 | 10 | 11 | 12 |
| BASE LAYER | | PAI | PAI | PAI | PAI | PAI | PAI | PAI | PAI | PAI | PAI | PAI | PAI |
| ELASTIC | NBR | 100 | 100 | 100 | 100 | 100 | 100 | — | — | — | — | 100 | 100 |
| LAYER | BR | — | — | — | — | — | — | 100 | — | — | — | — | — |
| (CONTENT | SBR | — | — | — | — | — | — | — | 100 | — | — | — | — |
| [PARTS BY | IIR | — | — | — | — | — | — | — | — | 100 | — | — | — |
| WEIGHT]) | CR | — | — | — | — | — | — | — | — | — | 100 | — | — |
| | CROSS- | 50 | 50 | 50 | 50 | 50 | 70 | 50 | 50 | 50 | 50 | 15 | 80 |
| | LINKING | | | | | | | | | | | | |
| | AGENT I | | | | | | | | | | | | |
| | INORGANIC | 100 | 100 | — | 100 | 100 | 100 | 100 | 100 | 100 | 100 | 170 | 100 |
| | FIRE- | | | | | | | | | | | | |
| | RESISTANT | | | | | | | | | | | | |
| | AGENT A | | | | | | | | | | | | |
| | INORGANIC | — | — | 100 | — | — | — | — | — | — | — | — | — |
| | FIRE- | | | | | | | | | | | | |
| | RESISTANT | | | | | | | | | | | | |
| | AGENT B | | | | | | | | | | | | |
| | ORGANIC | — | — | — | — | — | — | — | — | — | — | — | 120 |
| | FIRE- | | | | | | | | | | | | |
| | RESISTANT | | | | | | | | | | | | |
| | AGENT | | | | | | | | | | | | |
| | TBAHS | 1 | 1 | 1 | 1 | 1 | 1 | 1 | 1 | 1 | 1 | 1 | 2 |
| PROP- | TOTAL | 60 | 60 | 60 | 60 | 60 | 63 | 60 | 60 | 60 | 60 | 41 | 75 |
| ERTIES OF | ORGANIC | | | | | | | | | | | | |
| ELASTIC | COMPONENT | | | | | | | | | | | | |
| LAYER | MASS [%] | | | | | | | | | | | | |
| | INDENT- | 64.42 | 65.22 | 45.23 | 52.11 | 60.37 | 80.64 | 67.22 | 53.24 | 61.08 | 62.88 | 143.88 | 138 |
| | ATION | | | | | | | | | | | | |
| | YOUNG'S | | | | | | | | | | | | |
| | MODULUS: | | | | | | | | | | | | |
| | α [MPa] | | | | | | | | | | | | |
| | FRACTURE | 122 | 125 | 168 | 124 | 138 | 102 | 90 | 320 | 104 | 120 | 42 | 88 |
| | STRAIN: | | | | | | | | | | | | |
| | β [%] | | | | | | | | | | | | |
| | P: α × β | 7859 | 8153 | 7599 | 6462 | 8331 | 8225 | 6050 | 17037 | 6352 | 7546 | 6043 | 12144 |

| | | | | | | | | | | | | |
|---|---|---|---|---|---|---|---|---|---|---|---|---|
| ELASTIC LAYER | F•Cl | F•Cl | F•Cl | Cl | UV | F•Cl | F•Cl | F•Cl | F•Cl | F•Cl | F•Cl | F•Cl |
| SURFACE TREATMENT | | | | | | | | | | | | |
| WEAR TEST: REMOVAL | 8.16 | 7.23 | 8.23 | 10.36 | 5.64 | 3.43 | 11.34 | 1.33 | 10.22 | 9.03 | 12.95 | 2.34 |
| THICKNESS [μm] | | | | | | | | | | | | |
| DURABILITY TEST | GOOD | GOOD | GOOD | GOOD | GOOD | GOOD | GOOD | GOOD | GOOD | GOOD | GOOD | GOOD |
| FIRE RESISTANCE | VTM-1 | VTM-1 | VTM-1 | VTM-1 | VTM-1 | VTM-1 | VTM-1 | VTM-1 | VTM-1 | VTM-1 | VTM-0 | VTM-1 |

TABLE 2

| | | EXAMPLES | | |
|---|---|---|---|---|
| | | 13 | 14 | 15 |
| BASE LAYER | | PAI | PI | PAI |
| ELASTIC LAYER (CONTENT | NBR | 100 | 100 | 100 |
| [PARTS BY WEIGHT]) | CROSS-LINKING AGENT II | 50 | — | — |
| | CROSS-LINKING AGENT III | — | 50 | — |
| | CROSS-LINKING AGENT IV | — | — | 50 |
| | INORGANIC FIRE-RESISTANT AGENT A | 100 | 100 | 100 |
| | TBAHS | 1 | 1 | 1 |
| PROPERTIES OF | TOTAL ORGANIC | 60 | 60 | 60 |
| ELASTIC LAYER | COMPONET MASS [%] | | | |
| | INDENTATION YOUNG'S | 58.33 | 49.22 | 46.92 |
| | MODULUS: α [MPa] | | | |
| | FRACTURE STRAIN: β [%] | 135 | 148 | 153 |
| | P: α × β | 7875 | 7285 | 7179 |

| | | | |
|---|---|---|---|
| ELASTIC LAYER SURFACE TREATMENT | F•Cl | F•Cl | F•Cl |
| WEAR TEST: | 7.62 | 7.03 | 7.56 |
| REMOVAL THICKNESS [μm] | | | |
| DURABILITY TEST | GOOD | GOOD | GOOD |
| FIRE RESISTANCE | VTM-1 | VTM-1 | VTM-1 |

TABLE 3

| | | COMPARATIVE EXAMPLES | | | | | |
|---|---|---|---|---|---|---|---|
| | | 1 | 2 | 3 | 4 | 5 | 6 |
| BASE LAYER | | PAI | PAI | PAI | PAI | PAI | PAI |
| ELASTIC LAYER | NBR | 100 | 100 | 100 | 100 | 100 | 100 |
| (CONTENT [PARTS | BR | — | — | — | — | — | — |
| BY WEIGHT]) | SBR | — | — | — | — | — | — |
| | IIR | — | — | — | — | — | — |
| | CR | — | — | — | — | — | — |
| | CROSS-LINKING AGENT 1 | 30 | 15 | 50 | 50 | 10 | 100 |
| | INORGANIC FIRE-RESISTANT AGENT A | 100 | 100 | 45 | — | 175 | 100 |
| | INORGANIC FIRE-RESISTANT AGENT B | — | — | — | — | — | — |
| | ORGANIC FIRE-RESISTANT AGENT | — | — | — | — | — | 150 |
| | TBAHS | 1 | 1 | 1 | 1 | 1 | 2 |
| PROPERTIES OF | TOTAL ORGANIC COMPONET MASS [%] | 57 | 54 | 77 | 100 | 39 | 78 |
| ELASTIC LAYER | INDENTATION YOUNG'S | 22.26 | 19.35 | 39.22 | 52.43 | 150.3 | — |
| | MODULUS: α [MPa] | | | | | | |
| | FRACTURE STRAIN: β [%] | 164 | 222 | 155 | 183 | 30 | — |
| | P: α × β | 3651 | 4296 | 6079 | 9595 | 4509 | — |

| | | | | | | |
|---|---|---|---|---|---|---|
| ELASTIC LAYER SURFACE TREATMENT | F•Cl | F•Cl | F•Cl | F•Cl | F•Cl | — |
| WEAR TEST: REMOVAL THICKNESS [μm] | 54.3 | 54.26 | 11.11 | 1.82 | 25.3 | — |
| DURABILITY TEST | POOR | POOR | GOOD | GOOD | POOR | — |
| FIRE RESISTANCE | VTM-1 | VTM-1 | not | not | VTM-1 | — |

TABLE 4

| | | VTM-0 | VTM-1 | VTM-2 |
|---|---|---|---|---|
| JUDGMENT CONDITION | BURNING TIME AFTER 1^{ST} (t1) AND 2^{ND} (t2) | ≦10 (SECS.) | ≦30 (SECS.) | ≦30 (SECS.) |
| | FLAME REMOVAL FROM EACH SAMPLE | | | |
| | TOTAL BURNING TIME AFTER 10 FLAME | ≦50 (SECS.) | ≦250 (SECS.) | ≦250 (SECS.) |
| | REMOVALS (INCLUDING 2^{ND} FLAME CONTACT) | | | |
| | [t1 + t2 OF FIVE SAMPLES] | | | |
| | SUM OF BURNING TIME AFTER 2^{ND} FLAME | ≦30 (SECS.) | ≦60 (SECS.) | ≦60 (SECS.) |
| | REMOVAL AND KINDLING TIME (t2 + t3) | | | |
| | BURNING OR KINDLING TO REACH | NONE | NONE | NONE |
| | 125 mm-MARKING | | | |
| | IGNITION OF ABSORBENT COTTON BY | NONE | NONE | YES |
| | FALLING BODY | | | |

t1: BURNING TIME AFTER 1^{ST} FLAME REMOVAL
t2: BURNING TIME AFTER 2^{ND} FLAME REMOVAL
3: KINDLING TIME AFTER 2^{ND} FLAME REMOVAL

As is apparent from Tables 1-3, it was confirmed that the endless belt for the electrophotographic device of the present invention exhibited a sufficiently high degree of wear resistance in its surface portion (in the surface portion of its elastic layer), making it possible to effectively prevent wear or removal of the local areas of the belt surface (surface of the elastic layer) corresponding to the edge or end portions of the recording medium (sheet of paper), even where the endless belt is used as an intermediate image transfer belt of the electrophotographic device for a long period of time.

What is claimed is:

1. An endless belt for an electrophotographic device, comprising:
a base layer; and
an elastic layer formed on a surface of the base layer, by using a rubber composition including at least one rubber material and at least one inorganic filler,
wherein the elastic layer has 40-75% by mass of a total organic component, and a product P of an indentation Young's modulus (MPa) α and a fracture strain (%) β is within a range of 6000-50000.

2. The endless belt according to claim 1, wherein the indentation Young's modulus is within a range of 4-150 MPa.

3. The endless belt according to claim 1, wherein the fracture strain is within a range of 40-1500%.

4. The endless belt according to claim 1, wherein the at least one rubber material is selected from a group consisting of NBR, BR, SBR, IIR and CR.

5. The endless belt according to claim 1, wherein the rubber composition includes a resinous cross-linking agent.

6. The endless belt according to claim 1, wherein the at least one inorganic filler includes at least an inorganic fire-resistant agent.

7. The endless belt according to claim 1, wherein the elastic layer is formed by a dispenser coating method.

8. The endless belt according to claim 1, wherein the base layer is formed of one of a polyimide resin and a polyamideimide resin.
